(19) United States
(12) Patent Application Publication
(10) Pub. No.: US 2011/0261199 A1
(43) Pub. Date: Oct. 27, 2011

(54) DEVICE AND METHOD FOR DETECTING A DANGER SITUATION FOR A VEHICLE

(75) Inventors: Gerald SCHMIDT, Frankfurt Main (DE); Uwe BONNE, Buettelborn (DE)

(73) Assignee: GM GLOBAL TECHNOLOGY OPERATIONS LLC, Detroit, MI (US)

(21) Appl. No.: 13/094,462

(22) Filed: Apr. 26, 2011

(30) Foreign Application Priority Data
Apr. 27, 2010 (DE) 102010018331.8

(51) Int. Cl. H04N 7/18; B60Q 1/00

(52) U.S. Cl. 348/148; 340/438; 348/E07.085

(57) ABSTRACT

The invention relates to a device for detecting a danger situation for a vehicle with a scanning device, which scans the vehicle vicinity and from this detects possible danger situations, with a signaling device which upon scanning of a danger situation emits a warning signal perceptible to the driver, and with a driver monitoring device which scans the reaction of the driver to the warning signal, wherein the driver monitoring device detects if the reaction of the driver represents a danger-recognizing reaction and in this case verifies the danger situation.

### CROSS-REFERENCE TO RELATED APPLICATION

This application claims priority to German Patent Application No. 102010018331.8, filed Apr. 27, 2010, which is incorporated herein by reference in its entirety.

### TECHNICAL FIELD

The technical field relates to a device and a method which serve for detecting a danger situation for a vehicle. The term danger situation within the scope of the present invention is to mean obstacles lying in driving direction of the vehicle, additional road users, which give rise to the expectation of a collision with the vehicle or, generally, objects which could pose a dangerous situation to the vehicle, the vehicle occupants and/or other road users.

### SUMMARY

German publication DE 101 03 401 A1 describes a danger aversion system for a vehicle with a device for capturing driving status quantities, environmental data and the driver activity. A data processing device processes the captured data and activates a safety device in accordance with the predetermined control strategy. In addition, the vehicle comprises a device for the identification of the driver. From the driving status quantities, the environmental data and the data relating to the activity of the driver the data processing device derives a driver exposure to a load individually related to the driver which is utilized for adapting the control strategy and the intervention behavior of the danger aversion system.

The safety device comprises a driving dynamics control system in conjunction with an information and warning system. If a danger situation is detected information/a warning is passed to the driver. Should the driver fail to react to this in appropriate manner, the danger aversion system will intervene. This can be an intervention in the brake system, for example emergency braking, an intervention in the vehicle steering, for example an evasive maneuver or another driving-dynamic intervention. Such an intervention is aborted as soon as a driver reaction sufficient to avoid a threat or a reduction of the threat takes place.

The evaluation of the reaction of the driver to the warning/information is performed by a module of the danger aversion system provided for this purpose. With the known system there is however the risk that the system mistakenly rates non-critical situations as alleged danger situations. An intervention in the driving dynamics consequently initiated by the system results in a comfort reduction in such a situation and can in the most unfavorable of cases result in endangering the vehicle occupants and/or other additional road users present in the vicinity of the vehicle.

In view of the foregoing, at least one object is to provide a device and a method for detecting a danger situation for a vehicle, where a possible false activation of a danger avoidance device is reliably prevented. In addition, other objects, desirable features and characteristics will become apparent from the subsequent summary and detailed description, and the appended claims, taken in conjunction with the accompanying drawings and this background.

### SUMMARY

A device is provided for detecting a danger situation for a vehicle with a scanning device, which scans the vehicle vicinity and from this detects possible danger situations, and with a signal device, which upon detection of a danger situation emits a warning signal perceptible to the driver and with a driver monitoring device, which scans the reaction of the driver to the warning signal, wherein the driver monitoring device detects if the reaction of the driver represents a reaction recognizing the danger and wherein the device in this case verifies the danger situation.

A substantial advantage of the device is the increased safety for occupants of a vehicle and for other road users which are present in the vicinity of the vehicle. In addition, unnecessary irritations for the driver upon mistaken detection of an alleged danger situation are avoided because, if applicable, further measures and interventions for example in the form of an intervention in the driving behavior take place only after verification—that is after a further verification step or after confirmation based on the evaluation of the behavior of the driver or his reaction. The scanning device, which scans the vehicle vicinity, can be embodied in the form of a camera system, of an ultrasound, infrared, Radar or Lidar sensor system.

The warning signal emitted by the signal device can for example be an acoustic, visual or haptic signal. The haptic signal can for example be affected through vibrating of the steering wheel or of the driver's seat. In addition, signaling to the driver in the form of influencing the accelerator, brake or clutch pedal is conceivable. For example, signaling to the driver can be effected in the form of a slight movement of the brake pedal noticeable to the driver. Alternatively or additionally, a slight brake intervention, a reduction of the engine torque or only a short braking jerk can serve as warning signal.

The reaction of the driver to a warning signal can vary. It is conceivable that the driver in the event of an actual danger situation and warning in this regard reacts in that he takes the foot off the accelerator pedal, actuates the brake pedal or actuates the clutch. In addition, a reaction in form of a steering movement or a change of the line of vision—namely for example in the direction of an obstacle causing the danger situation—is conceivable.

In an embodiment, the device upon a verified danger situation supplies a danger avoidance device with information representing the danger situation. The term “provides” within the scope of the present invention means that the device makes available information representing the danger situation to the danger avoidance device in a suitable form, for example as data packet. The information in this case is preferably in a form in which it can be directly processed by the danger avoidance device and used for avoiding the danger. Through this configuration an intervention in the driving dynamics of the vehicle through the danger avoidance device can be carried out particularly effectively upon detection of a danger situation. Intervening in the driving dynamics can for example be realized in the form of a braking operation or by a steering of the vehicle controlled by the danger avoidance device.

According to another embodiment, the driver monitoring device comprises a camera system. Because of this it is possible for example to record the movements of the driver and to use these for detecting if the reaction of the driver represents a danger-recognizing reaction.

According to another embodiment, the driver monitoring system comprises an ultrasound sensor system. This provides a particularly simple possibility of monitoring the driver. Through the ultrasound sensor system the movements of the driver can be recorded and used for detecting if the reaction of the driver represents a reaction detecting a danger.

According to another embodiment, if the reaction of the driver represents a reaction detecting a danger, is effected by means of the line of vision of the driver. The evaluation of the line of vision of the driver represents a particularly representative version for detecting if the reaction of the driver represents a danger detecting reaction. By means of the line of vision it can be detected for example if the driver sees an object and recognizes its danger potential, which the scanning device has detected as an object triggering the danger situation. Here, in another embodiment of the device, the line of vision of the driver is scanned by a camera system.

According to a further embodiment, detecting whether the reaction of the driver represents a danger-recognizing reaction is effected by means of the position of the accelerator pedal. This provides a particularly simple possibility for detecting if the reaction of the driver represents a danger-recognizing reaction. For example, an actuation of the accelerator pedal allows drawing the conclusion that a driver has not recognized a possible danger situation.

According to a further embodiment, detecting if the reaction of the driver represents a danger-recognizing reaction is effected by means of the position of the brake pedal. The evaluation of the brake pedal position also allows drawing a conclusion as to whether the driver recognizes a possible danger situation. For example, the actuation of the brake pedal can be seen as an indication that the driver recognizes a danger situation.

According to a further embodiment, detecting if the reaction of the driver represents a danger-recognizing reaction is effected by means of the position of the clutch pedal. The position of the clutch pedal can provide a simple indication as to whether the driver recognizes the danger situation. An actuated clutch pedal allows for example to draw the conclusion that a danger situation has been recognized.

According to a further embodiment, the driver monitoring device comprises a decision-making unit based on an artificial neuronal network. This provides a particularly advantageous possibility of deciding, by means of the recorded reaction of the driver to the warning signal, if the driver recognizes the danger situation.

The term artificial neuronal network is to mean a programming of a computer such that the computer simulates the information processing of natural neuronal networks—such as for example the brain. Because of this, the reaction of the driver to the warning signal can be recorded as information and processed by the artificial neuronal network. This processing results in a decision as to whether from the reaction of the driver a danger-recognizing reaction can be concluded.

In an embodiment, the artificial neuronal network prior to the usage can be taught in a driver monitoring device by way of a multiplicity of trial runs with a simulated danger situation and test drivers. In addition, the artificial neuronal network during the course of the usage can independently optimize itself through further learning processes. Because of this, a decision, as to whether the reaction of the driver represents a danger-recognizing reaction, is correctly made with an increased probability.

According to another embodiment, the driver monitoring device comprises a decision-making unit based on probability hypotheses. This provides a particularly simple possibility of detecting a danger-recognizing reaction of the driver. Here, the various reactions of the driver can be assigned predetermined probabilities that the respective reaction represents a danger-recognizing reaction. Here, not only individual reactions but also combinations of reactions of a driver can be rated. By means of predetermined threshold values for the calculated probability that the driver reaction represents a danger-recognizing reaction the decision is made if the reaction of the driver to the warning signal represents a danger-recognizing reaction.

The method according to the invention for detecting a danger situation for a vehicle provides that the vehicle vicinity is scanned and upon detection of a danger situation a warning signal perceptible to the driver is emitted, upon which the reaction of the driver to the warning system is recorded and wherein it is detected if the reaction of the driver represents a danger-recognizing reaction, and wherein in this case the danger situation is verified. Thus, a particularly reliable method for verifying a danger situation for a vehicle is created. Through the verification (that is the autonomous method confirmation) the mistaken detection of an alleged danger situation and irritations connected with this are reliably avoided for the driver and his surroundings.

### BRIEF DESCRIPTION OF THE DRAWINGS

The present invention will hereinafter be described in conjunction with the following drawing figures, wherein like numerals denote like elements, and:

FIG. 1 is an exemplary embodiment of a device according to an embodiment; and

FIG. 2 is schematically the flow of the method according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

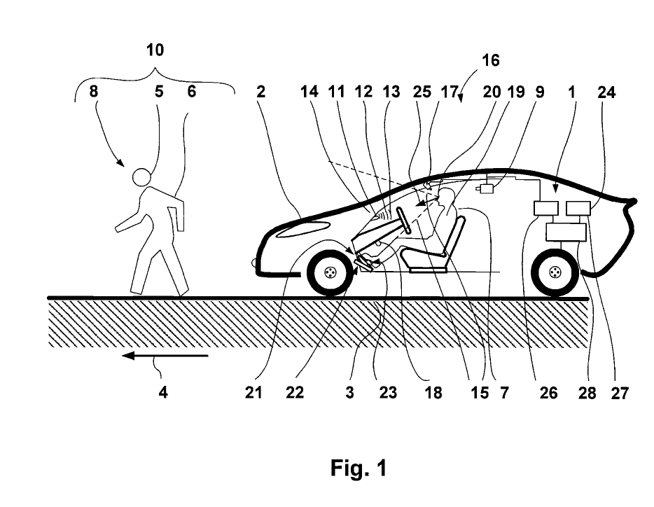

FIG. 1 shows a device 1 according to an embodiment in a vehicle 2, which moves on a road 3 in driving direction 4. Seen from the vehicle 2 in driving direction 4 an obstacle 5 in the form of a pedestrian 6, who to the vehicle 2 and a driver 7 constitutes a danger situation 8 is located. A scanning device 9 scans the vehicle vicinity 10 and in the process the danger situation 8, which is the pedestrian 6. When the pedestrian 6 is scanned by the scanning device 9 a signaling device 11 emits a warning signal 12 perceptible to the driver 7. The warning signal 12 comprises an acoustic and visual warning signal 13, which is emitted in the region of the vehicle instruments 14 and is thus present in the perception range 15 of the driver 7.

Upon emitting of the warning signal 12 a driver monitoring device 16 with a camera system 17 and with an ultrasound sensor system 18 simultaneously scans the reaction of the driver 7 to the warning signal 12. The camera system 17 records the reaction of the driver 7 to the warning signal 12 by evaluating the movements of his upper body 19 and the expressions 20 of the driver 7. The ultrasound sensor system 18 scans the position of the accelerator pedal 21, of the brake pedal 22 and of the clutch pedal 23. In the process, information representing the reaction of the driver 7 to the warning signal 12 is directed to a decision-making unit 24 associated with the driver monitoring device 16.

By evaluating the line of vision 25 of the driver 7, of the position of the accelerator pedal 21, of the position of the brake pedal 22 and of the position of the clutch pedal 23 the decision-making unit 24 decides if the reaction of the driver 7 represents a danger-recognizing reaction. The decision-making unit 24 in this case comprises a decision-making module 26 based on an artificial neuronal network and a decision-making module 27 based on probability hypotheses.

If the driver monitoring device 16 based on the decision of the decision-making unit 24 detects that the reaction of the driver 7 to the warning signal 12 is a danger-recognizing reaction, the danger situation 8 is confirmed (verified). In this case the driver monitoring device 16 sends information representing the danger situation to a danger avoidance device 28. The danger avoidance device 28 if applicable intervenes in the driving dynamics of the vehicle 2. Intervention is effected for example through an automatic braking operation and/or through a steering operation of the vehicle 2 controlled by the danger avoidance device 28. Because of this, a collision of the vehicle 2 with the obstacle 5 (i.e., pedestrian) is avoided.

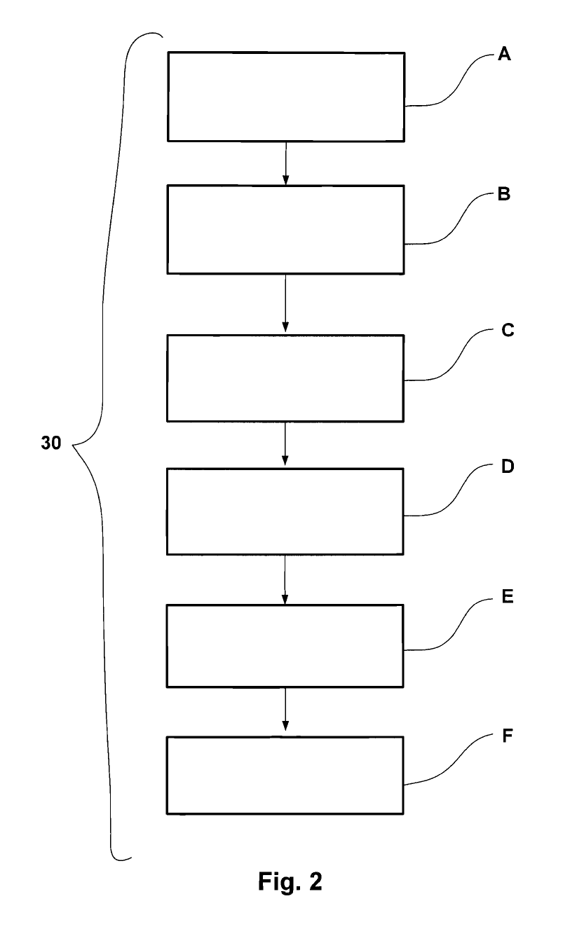

FIG. 2 schematically shows a possible sequence of the method 30 according to the invention for detecting a danger situation for a vehicle, as shown in FIG. 1. The method starts in method step A, in which the vehicle vicinity is scanned. Method step A is followed by method step B, in which upon detection of a danger situation, a warning signal perceptible by a driver is emitted. Following this, in a further process step C, the reaction of the driver to the warning signal is scanned. Following this, in a method step D it is detected if the reaction of the driver is a danger-recognizing reaction and in a method step F the danger situation in the event that the reaction of the driver represents a danger-recognizing reaction is verified and a danger-averting measure such as for example a speed reduction or enforced braking is initiated.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for detecting a danger situation for a vehicle, comprising:
a scanning device configured to scans a vehicle vicinity and detect a potential danger situation;
a signaling device configured to emit a warning signal upon detection of the potential danger situation; and
a driver monitoring device configured to:
scan a driver reaction to the warning signal;
detect if the driver reaction represents a danger-recognizing reaction; and
verify the danger situation if the driver reaction represents the danger-recognizing reaction.

2. The device according to claim 1, further comprising a danger avoidance device that is configured to receive information representing the danger situation upon verification of the danger situation by the driver monitoring device.

3. The device according to claim 1, wherein the driver monitoring device comprises a camera system.

4. The device according to claim 1, wherein the driver monitoring device comprises an ultrasound sensor system.

5. The device according to claim 1, wherein the detection if the driver reaction represents the danger-recognizing reaction takes place subject to an evaluation of a driver line of vision.

6. The device according to claim 1, wherein the detection if the driver reaction represents the danger-recognizing reaction takes place subject to an evaluation of an accelerator pedal position.

7. The device according to claim 1, wherein the detection if the driver reaction represents the danger-recognizing reaction takes place subject to an evaluation of a brake pedal position.

8. The device according to claim 1, wherein the detection if the driver reaction represents the danger-recognizing reaction takes place subject to an evaluation of a clutch pedal position.

9. The device according to claim 1, wherein the driver monitoring device comprises a decision-making unit based at least in part on an artificial neuronal network.

10. The device according to claim 1, wherein the driver monitoring device comprises a decision-making unit based at least in part on probability hypotheses.

11. A method for detecting a danger situation for a vehicle, comprising:
scanning a vehicle vicinity with a scanner to detect the danger situation;
emitting a warning signal upon detection of the danger situation;
scanning a driver reaction to the warning signal; and
determining if the driver reaction represents a danger-recognizing reaction; and
verifying the driver reaction represents the danger-recognizing reaction.

12. The method according to claim 11, further comprising initiating a danger situation intervention in driving dynamics of the vehicle upon the verifying the driver reaction represents the danger-recognizing reaction.

13. The method according to claim 11, further comprising receiving information with danger avoidance device that represents the danger situation upon verification of the danger situation by a driver monitoring device.

14. The method according to claim 11, wherein the scanning the driver reaction to the warning signal is performed by a driver monitoring device.

15. The method according to claim 14, wherein the driver monitoring device comprises a camera system.

16. The method according to claim 14, wherein the driver monitoring device comprises an ultrasound sensor system.

17. The method according to claim 11, wherein the detecting if the driver reaction represents the danger-recognizing reaction takes place subject to evaluating a driver line of vision.

18. The method according to claim 11, wherein the detecting if the driver reaction represents the danger-recognizing reaction takes place subject to an evaluating an accelerator pedal position.

19. The method according to claim 11, wherein the detecting if the driver reaction represents the danger-recognizing reaction takes place subject to evaluating a brake pedal position.

20. The method according to claim 11, wherein the detecting if the driver reaction represents the danger-recognizing reaction takes place subject to evaluating of a clutch pedal position.
